(19) United States
(12) Patent Application Publication
(10) Pub. No.: US 2026/0127495 A1
(43) Pub. Date: May 7, 2026

(54) SYSTEMS AND METHODS FOR A COMPUTING ARCHITECTURE AND ORCHESTRATION OF HARDWARE RESOURCE USAGE FOR DISTRIBUTED MACHINE LEARNING MODEL TRAINING

(71) Applicant: Omniscience Strategies Corporation, Cheyenne, WY (US)

(72) Inventors: Sunil Rawat, Sunnyvale, CA (US); Manu Shukla, Los Altos, CA (US)

(21) Appl. No.: 19/354,194

(22) Filed: Oct. 9, 2025

Related U.S. Application Data
(60) Provisional application No. 63/706,297, filed on Oct. 11, 2024.

(51) Int. Cl. G06N 20/00; G06F 18/2321

(52) U.S. Cl. CPC G06N 20/00; G06F 18/2321

(57) ABSTRACT

A method and apparatus for distributing training of a machine learning model using hardware resources of a cluster of computing nodes are described. The method includes receiving, by a first computing node of the cluster of computing nodes, a first plurality of graphics processing unit (GPU) machine learning model (MLM) training operations for training a first layer of neurons of a MLM. The method also includes transforming the first plurality of GPU MLM training operations to a first plurality of corresponding central processing unit (CPU) jobs. The method may also include distributing, by the first computing node to a set of computing nodes of the cluster of computing nodes, the first plurality of CPU jobs, the first computing node and the set of computing nodes of the cluster of computing nodes comprising a plurality of CPUs and a plurality of RAM memory shared by the cluster of computing nodes.

### RELATED APPLICATIONS

The present application is a non-provisional of, and claims the benefit of, U.S. Provisional Application No. 63/706,297, filed Oct. 11, 2024, which is incorporated by reference herein in its entirety.

### BACKGROUND

Organizations provide software-based services to their users, such as web-based services, services provided by mobile applications, services provided via downloaded and installed software, etc. Such software-based services often employ trained machine learning models to enhance the function and user experience provided by the software-based services. One type of machine learning model used within such software-based services is a large language model, which is a machine learning model capable of deploying artificial intelligence to process and generate language. Other machine learning models, such as generative based, transformer based, neural network or deep learning based, etc. models may also be used by software-based applications to enhance the function and user experience associated with the software application. Each of these models, however, must be trained prior to deployment by a software application. The training process utilizes the training data set to learn statistical relationships between words, their semantic meanings, how words relate to one another, how words of a query are related to words of an answer, etc. Once trained, for example, a large language model may perform various tasks, such as generating words, sentences, paragraphs, etc. in response to a prompt. As other examples, a trained large language model can summarize text input into the large language model, can write software code based on prompts, can generate audio data in the form of computer-generated human speech in response to a text or spoken prompt, as well as other operations.

Training large language models, however, is an extremely compute intensive process that includes storing and using a massive amount of training data, and iteratively training the large language model on this training data. Even with the dedication of a large amount of computing resources (e.g., processing and memory resources), such training can take years to complete consuming a vast amount of computation resources, memory resources, and power resources of the computer processing systems that are used to perform the large language model training.

For example, current large language models are neural network based models and employ 100 or more decoder layers with 50,000 or more neurons per decoder layer. Each neuron performs complex matrix based operations, with matrices exceeding dimensions of 12,000 by 12,000. Therefore, a number of calculations to be made by such a machine learning model is on the order of 5.36*10¹¹ floating point operations per second. Then, when training such a large language model, both forward pass training operations and backward pass error correction is performed, which his repeated millions and millions of times, resulting not only in the need for significantly processing resources as training typically requires years of compute time, but also massive memory footprints is required to store the massive amounts of data generated during each training pass. Therefore, a unique computing problem is created by large language models in how to effectively train large language models and how to efficiently use computational resources in the training process in a way that helps reduce consumption of computational resources, save system operating power, and otherwise improve computational efficiency.

One approach to more efficiently training large language models, as well as other models, includes using graphical processing unit (GPU) processors. GPUs enable machine learning models and training processes, which need to analyze and process a lot of data at once, to be performed in a parallel fashion. Using GPUs to train machine learning models, however, has significant drawbacks. In GPUs, memory available to each GPU is in short supply. Furthermore, the number of GPUs are also often in short supply, and even though they are faster than CPUs, the amount of memory available to each GPU to perform its task hinders distribution of tasks to multiple GPUs. This is because a distributed task utilizing GPUs cannot build a massive footprint of memory for execution of these tasks due to the limited memory available to each GPU, as required when training large language models, as well as other complex machine learning models. Thus, the distribution, and then recombination, of tasks to GPUs start to perform tensor distribution, which occurs over a large area network (LAN) between GPUs. The transmissions over a LAN of the tensors to other GPUs with available resources incurs delays, as network-based transmission is extremely slow compared to performing computational operations on a machine, which further makes the use of GPUs very inefficient.

Furthermore, due to memory limitations with GPUs, only a small window of training may be performed. After that small window, GPU distributed processing must distribute tensors over I/O interfaces and LANs as discussed above. However, the small windows and tensor distributions takes the distributed and parallel process of model training, and functionally transforms the process into a substantially linear or sequential process. Thus, the processing speed benefits of GPUs are nullified by the computing requirements of training large language models, and other machine learning models.

Alternative approaches to more efficient machine learning model training, such as including sparse matrix pruning in software, quantization, competing GPUs, ASICs, FPGAs, and wafer scale chips have their own limitations that do not make their deployment to large language machine learning model training optimal.

Therefore, a computing technique and hardware architecture that provides for more efficient resource utilization and improved efficiency of training complex machine learning models is needed. Furthermore, this need will grow and become more pressing as machine learning models, and their training, become more complex.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of an exemplary system architecture for performing distributed machine learning model training and deployment.

FIG. 2 is a block diagram of one embodiment of a machine learning model training system including a machine learning training computing cluster architecture.

FIG. 3 is a block diagram of one embodiment of a CPU cluster manager of the machine learning training computing cluster architecture.

FIG. 4A illustrates one embodiment of an exemplary structure of a neural network that can be used by large language models;

FIG. 4B illustrates one embodiment of back propagation operations that can be used by a neural network that forms a large language models;

FIG. 5 is a block diagram of one embodiment of method for orchestration CPU operations in a cluster of computing nodes for training a machine learning model;

FIG. 6 illustrates one embodiment of a method for using keys and values when orchestrating CPU operations in a cluster of computing nodes;

FIG. 7 illustrates one embodiment of a method for using in-memory data during orchestrated CPU operations in a cluster of computing nodes.

FIG. 8 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “distributing”, “executing”, “transforming”, “storing”, “generating”, “determining”, “detecting”, “assigning”, “tracking”, “training”, “updating”, “using”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

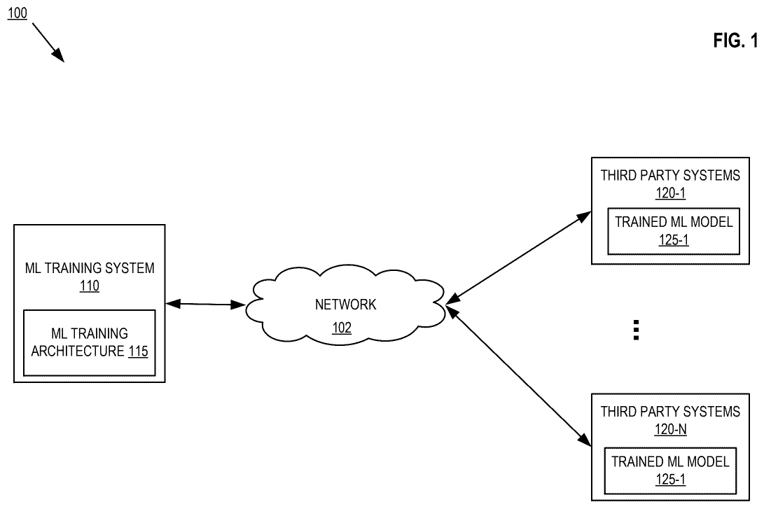

FIG. 1 is a block diagram of an exemplary system architecture 100 for performing distributed machine learning model training and deployment.

In one embodiment, the system 100 includes one or more computer systems for training and deploying machine learning models, such as machine learning (ML) training system 110 and one or more third party systems 120-1 through 120-N (e.g., web search systems, social media platforms, fitness tracking platforms, user blogging systems, third party data aggregators or other systems that will integrate trained ML models within the software systems of the third party systems). In one embodiment, one or more of the third party systems 120 may be a mobile computing device, such as a smartphone, tablet computer, wearable computing device, etc., as well as other devices capable of running a software system, accessing a web-based software system, etc. with an integrated ML model. The ML training system 110 and one or more of the third party systems 120 may also be computing devices, such as one or more server computer systems, desktop computer systems, etc.

The ML training system 110 and one or more of the third party systems 120 may be coupled to a network 102 and communicate with one another using any of the standard protocols for the exchange of information. In one embodiment, one or more of the ML training system 110 and one or more of the third party systems 120 may run on one Local Area Network (LAN) and may be incorporated into the same physical or logical system, or different physical or logical systems. Alternatively, ML training system 110 and one or more of the third party systems 120 may reside on different LANs, wide area networks, cellular telephone networks, etc. that may be coupled together via the Internet but separated by firewalls, routers, and/or other network devices.

In one embodiment, ML training system 110 may reside on a single server computer system, or be distributed among different servers, coupled to other devices via a public network (e.g., the Internet) or a private network (e.g., LAN). In embodiments, ML training system 110 provides for efficient and cost effective machine learning model training for complex machine learning models, such as large language models, transformer based models, and other models. In embodiments, ML training architecture 115 of the ML training system 110 expresses ML models in the distributed x86 cluster language to horizontally scale out ML model training on demand. ML training architecture 115 further allows high velocity, higher accuracy inference because x86 memory (e.g., DDRAM available to CPUs used in distributed x86 operations) is orders of magnitude cheaper than GPU memory. Even more, it will allow training to occur across datacenters, eliminating the current electric power bottlenecks and need for gigawatt scale datacenters, which would dramatically lower computing cost and computing time by as much as a 10× speedup over GPU based machine learning model training. In embodiments, as discussed herein, a cluster of computing systems that execute CPU based operations, such as x86 operations, is used to perform the orchestrated training operations.

In embodiments, ML training architecture 115 can leverage Apache Spark's Resilient Distributed Datasets (RDDs) to efficiently distribute and process large language learning models and other transformer algorithms. However, other architectures, such as Ray can also be used to distribute machine learning model training, as discussed herein. Ray, for example, distributes AI model training and other operations as stateless tasks orchestrated through a metadata store. Ray unifies actor and task parallel abstractions over a dynamic execution engine distributed in memory and computer for tasks over a cluster. However, to avoid obscuring the present invention, the below discussed embodiments use Spark as an example execution architecture that uses clusters of CPUs and their shared resources to perform distributed and parallelized training of large and complex machine learning models, such as large language models.

In embodiments, the ML training architecture 115 is configured to perform the operations as discussed in greater detail below.

In embodiments, ML training architecture 115 performs in-memory computations during training of a large language or other complex machine learning model. In embodiments, compute and data are combined in memory by ML training architecture 115, with fault-tolerant directed acyclic graph (DAG) based computations on RDDs. RDDs are units of data and compute (together) that are capable of being executed in-memory, such as in memory available to CPUs in a cluster of CPUs, such as CPU clusters in a data center. In an embodiment, ML training architecture 115 utilizes the Spark architecture, and is configured as to which RDDs can be distributed, when to execute RDDs, and then stitches them back together using a CPU based orchestration process, as discussed in greater detail below. That is, RDDs are small elements of a larger problem, such as sub-operations used when training an LLM. For example, a larger problem F may be represented by smaller problems each having a relationship with one another, as F=f(a)+f(b)+f(c). Then, each fᵢ can be encapsulated as an RDD (compute and data unit) that utilizes the data and performs the function associated with fᵢ. Beneficially, ML training architecture 115 orchestrates distribution of each of f(a), f(b), and f(c) for execution in parallel and in memory of a computing cluster's shared hardware resources, and the results combined/stitched back together for computation of F, where F may also be encapsulated as an RDD and be part of a larger problem. Furthermore, the results may be identified and persisted in the memory footprint created by the cluster of computing systems, so that the persisted operations can be re-used by other training operations, and further accessed in memory by the other training operations, to avoid both time-consuming and wasteful re-computation, as well as to avoid delay caused by transferring results between memories of systems.

In embodiments, the ML training architecture 115 knowing what data is to be worked on, can distribute RDDs to be computed on their own and then stitched back together. In embodiments, keys are used to track RDDs, organize RDDs, determine how to stitch RDD results back together based on key values. The keys are, for example, uniquely allocated data, such as monotonically increasing integers, hash values, identifiers generated by a random number generator, etc. that uniquely identify each task and computational result of the task, enabling other tasks to access the results throughout the machine learning model training process.

Considering transformer LLMs, the problem becomes extremely complex from a distribution and recombination standpoint. In embodiments, the steps and combination, as well as transformations in between stages, of an LLM may each be divided into RDDs by ML training architecture 115, distributed for processing in memory, and then recombined by ML training architecture 115. Using x86 distribution of processing jobs enables the distribution for in-memory processing by CPUs. Beneficially, CPUs have orders of magnitude more available memory than GPUs, and may therefore utilize more parallelization to more efficiently execute the distributed RDD (compute and data) units during training of the LLM.

Furthermore, RDDs ensure data consistency by being immutable. Once data is created by the distributed process performed by ML training architecture 115, it cannot be changed, which is crucial for maintaining data integrity during machine learning model training using parallel processing. In embodiments, and as discussed below, RDDs may be divided into partitions, with each subset processed in an executor. The partitions are processed in parallel across nodes of a cluster, allowing for efficient handling of large datasets associated with larger partitions than a GPU could handle. For transformer-based models, in embodiments, data for training transformer models (e.g., text, video) is loaded by ML training architecture 115 into RDDs, which are then partitioned and distributed across multiple computing nodes of a computing cluster to ensure parallel processing and scalability, and access to a large memory footprint in the form of shared cluster memory.

As discussed herein, in embodiments, all computations are performed in every epoch in each layer of the transformer architecture in memory. Parallelization of computations optimize for underlying cluster by framework when modeled by ML training architecture 115 in RDD operations.

For example, large text datasets for language models are computed upon in smaller chunks whenever mathematical computations are determined by ML training architecture 115 to be allowed, each processed on different nodes/executors independently to accelerate training. Thus, data and compute resources of distributed systems (e.g., nodes) are used, and x86 can recombine the immutable results so there is no accuracy loss.

In embodiments, ML training architecture 115 handles operations like map, flatMap in PairRDDFunctions, filter, and reduceByKey applied as transforms and actions to RDDs to create new RDDs. In embodiments, these transformations are lazy, meaning they build up a logical execution plan without performing any computation until an action is called. The action, when called causes the execution plan and associated RDDs to be executed when such execution is needed, so that memory and compute resources are not reserved until they are needed, which frees up memory and compute operation for active tasks, further enhancing efficiency.

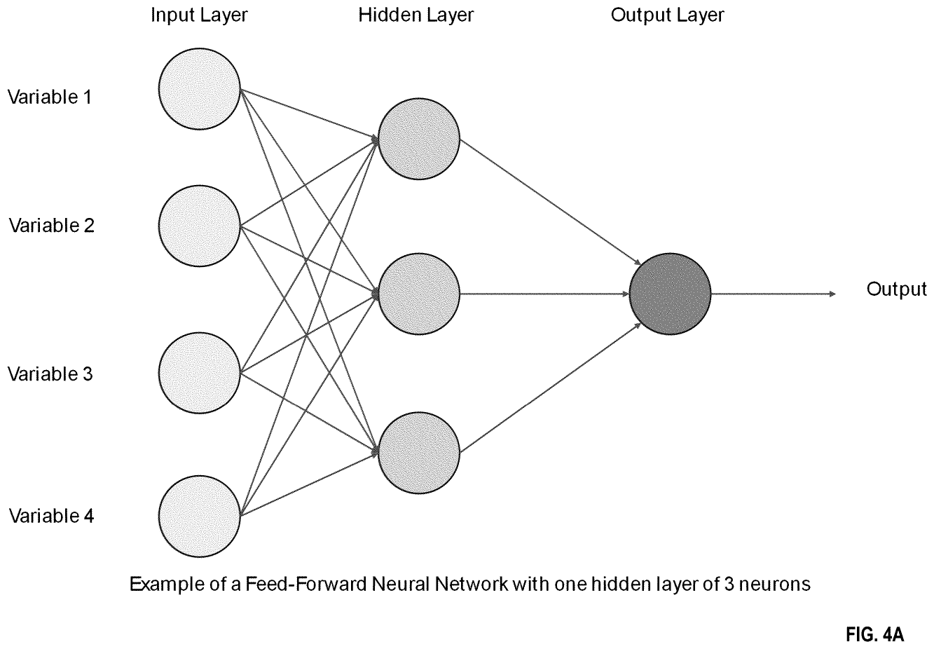

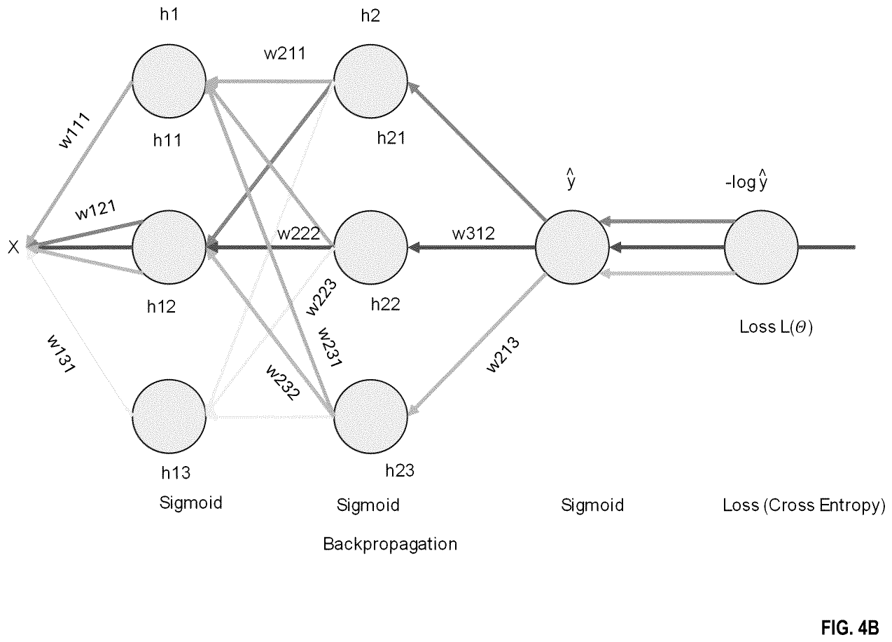

ML training architecture 115 provides for parallel processing of transformer ML models. FIG. 4A illustrates one embodiment of an exemplary structure of a neural network that can be used by large language models. The illustration of FIG. 4A shows an example neural network, that can be used to implement a transformer ML model. Variables are used as inputs (e.g., tokenized and transformed data) to a first, input layer of the machine learning model. In embodiments, each layer includes neurons that perform operations, such as matrix multiplications for forward and backward propagations (FNN) with gradient descent and attention mechanisms. Furthermore, each layer is fully connected, meaning that each neuron from layer N is connected to each neuron of a following layer N+1. Thus, each neuron in layer N+1 uses each of the results from the neurons in layer N as input when performing its operations. The matrix operations, as discussed above, are large and require an immense number of floating point operations per second to be performed. However, as discussed herein, the operations of the neurons are orchestrated during training so that computation of each layer of the ML model is parallelized using RDD distribution and transformations, all performed in memory (e.g., RAM) and utilizing the processing resources (e.g., CPUs) of a cluster of computing systems. Beneficially, by performing the operations in memory, and then persisting operational results in memory (e.g., of a computing cluster), the neurons of each subsequently layer can access the needed results of a prior layer of neurons in a shared cluster memory, rather than having to transfer the results between different systems (e.g., remote systems, systems distributing physical resources, etc.). The in-memory computations of each machine learning model layer of the fully-connected model (e.g. performed as RDDs utilizing distributed x86 jobs) significantly reduces overall computational time over prior distributed techniques (e.g., GPU based ML training techniques) because neuron results are not transferred using network-based communications and are instead accessed in the shared cluster memory, and there is no need for re-computation as each neuron of a subsequent layer may simply access the results from the shared memory. Therefore, a surprising result occurs because although CPUs offer slower processing speed than GPUs, clusters of CPUs are in great supply and offer an extremely large memory footprint in the form of shared RAM. Thus, job distribution and parallelization, for example using Spark to distribute x86 jobs, which benefit from in-memory storage and data access, significantly improves the processing performance of large language model training. The improvement can be on the order of months of computing time required to train a large language model, rather than years as required to current training techniques. Thus, significant savings and preservation of compute, memory, and power is achieved through the techniques disused herein.

FIG. 4B illustrates one embodiment of back propagation operations that can be used by a neural network that forms a large language model. The back propagation is also able to use the in-memory neuron results when updating weights applied to neuron calculations of the neural network model, such as the model illustrated in FIG. 4A.

In some embodiments, a computational graph generated for these operations is computationally traversed by key-value pair-based operations all in memory. For example, in an embodiment, ML training architecture 115 applies an attention mechanism on different segments of a dataset in parallel using map.

Transformers are the algorithms used in building Large Language Models (LLMs). LLMs have the ability, once trained, to generate human like responses and are often referred to as Generative Pretrained Transformers (GPT). A transformer algorithm consists of multi-head attention blocks and a series of encoders and decoders. These are Feed Forward Network (FFN) deep learning networks which can consist of many layers.

ML training architecture 115 provides for parallelization from multiple aspects during training: (a) parallelization of attention blocks in a transformer, and (b) parallelization of the FFN computations within a layer of the transformer.

ML training architecture 115's computational approach on higher level attention blocks based parallelization and parallelization within a layer is to perform those computations by flooding them in memory, and based on the detection of any independence in those computations, perform them in parallel. Thus, both the attention block and encoder level computations can be parallelized by ML training architecture 115.

In embodiments, the RDD constructs of the x86 architecture used by ML training architecture 115 are therefore used to perform both coarse (attention blocks) and fine (FNN operations) grained operations in parallel in memory, and persist results in the memory, which as discussed herein is a shared cluster computing system memory.

Furthermore, ML training architecture 115, in embodiments, maintains lineage Information for distributed computations. In embodiments, the RDDs used by ML training architecture 115 maintain lineage information data, which tracks the series of transformations applied to build a dataset. In case of node failure (e.g., a data center failure, system fault, unforeseen disaster in a geographic location, power outage, memory corruption, etc.), when the distributed system used by ML training architecture 115 performs one or more training operations and encounters lost data and/or failed processors, ML training architecture 115 uses the lineage information across RDDs to recompute the lost data. If, for example, the lost data represents a portion or subset of a larger operation, only the lost data need be recomputed and the larger operation is not needed be recomputed. Therefore, there is no data loss due to node failure, which is not possible in prior DL approaches. Furthermore, recomputing the lost data may be performed much more efficiently by filling gaps based on the lineage data associated with the RDDs.

Furthermore, in embodiments, during the training of Transformer models by ML training architecture 115, any failure in a cluster of nodes can be recovered by ML training architecture 115 triggering recomputing the lost data from the lineage information data, ensuring seamless recovery and continued operation of ML training.

In an embodiment, for example, if a node processing a batch of text data fails, ML training architecture 115 can use the x86 architecture to recompute the transformations applied to the initial data partition, ensuring consistency and robustness.

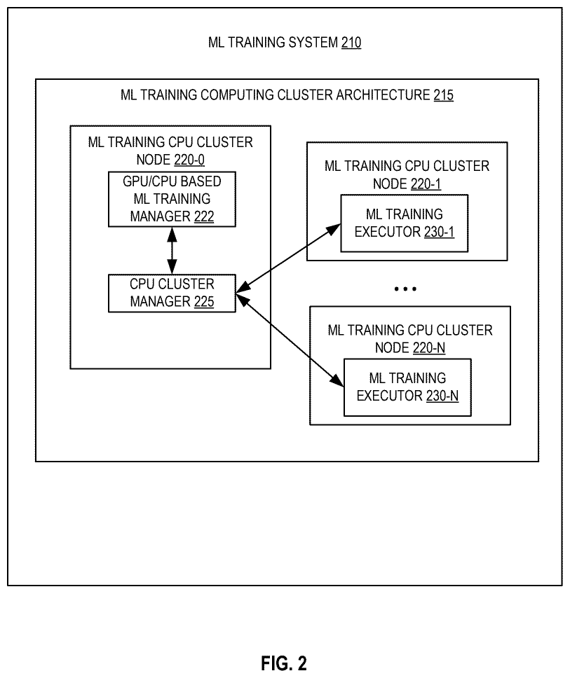

FIG. 2 is a block diagram of one embodiment of a machine learning model training system 210 including a machine learning training computing cluster architecture 216. The machine learning model training system 210 provides additional details for the machine learning model training system 110 discussed above.

In embodiments, machine learning training computing cluster architecture 216 includes a plurality of computing systems. The computing systems are cluster nodes, such as ML training CPU cluster node 220-0, and ML training CPU cluster node 220-1 through 220-N. Each cluster node of architecture 216 is a computing system that includes hardware components (e.g., CPU(s), random access memory (RAM), and other storage), network interfaces for cluster communication, and software (e.g., operating system, cluster management software, etc.). The cluster of computing systems forms a pool of shared processing resources, such as the CPUs of the individual cluster nodes, and also forms a pool of shared RAM memory. The pool of shared memory is memory accessible to and used by the pool of CPUs of the cluster, enabling the pool of CPUs to store data to, perform operations on, and access the data from, the pool of shared memory as local RAM. Thus, using the pool of cluster memory as shared RAM enables the CPUs of the cluster to perform fast in-memory operations on the data, such as ML model training operation discussed herein.

In embodiments, the cluster of nodes perform distributed ML training as discussed herein using x86 CPU based operations. In embodiments, the Spark framework for job distribution and parallelization is used. For performing the training operations, node 220-0 is a master or control node of the training process and coordinates and manages cluster operations, makes training decision, manages cluster metadata, etc., and nodes 220-1 through 220-N are executor nodes that execute the computational workloads (e.g., performing matrix based operations for neurons of a ML model during training, performing back-propagation calculations to refine neuron weighs, etc.).

To manage and coordinate the many and complex training operations for training a large language model or other complex machine learning model, node 220-0 includes GPU/CPU based ML training manager 222 and CPU cluster manager 225. GPU/CPU based ML training manager 222 is a platform that manages the operations of training a complex machine learning model, such as an LLM. In some embodiments, GPU/CPU based ML training manager 222 executes a training system, such as a ML training framework based on Pytorch, which is an open-source machine learning library used for training models and deep learning applications. That is, a model can be defined in Pytorch (e.g., a neural network, how many layers, how many neurons per layer, how the neurons are connected per layer, etc.), and data sources can be defined in Pytorch (e.g., local or remote data stores of training data). Pytorch will generate a sequence of operations that implement the forward pass and back propagation training operations for the incremental training of the defined model, and will track training operations to coordinate the training process of the defined network (e.g., a neural network for a large language model). In embodiments, however, Pytorch uses a mixture of CPU and GPU based operations, and almost exclusively GPU based operations to distribute computational tasks during ML model training. Relying on GPU based operations and processing when training complex large language models has several technical drawbacks, as discussed herein. Furthermore, existing distributed learning (DL) libraries like Tensorflow and Pytorch allow for some distribution techniques, but mainly involve data distribution. Data distribution tends to be lossy for accuracy, and thus is not a good option for distributed learning. Additionally, hybrid distribution on both data and compute is difficult as current implementations and nature of DL techniques implementation is heavily sequential, and a lack of memory on GPUs makes it difficult to do parallelization of compute operations across large number of GPUs as exchange of parameters between GPUs becomes a bottleneck.

In embodiments, ML training CPU cluster node 220-0 utilizes a distribution paradigm that distributes model training on large amounts of memory available. ML training CPU cluster node 220-0 performs distribution to data center CPUs, which typically have much more available memory, such as in the Spark framework to give many opportunities to make computations all performed in memory across large deep DL networks without accumulating accuracy loss over layers and epochs. For example, ML training CPU cluster node 220-0 will distribute operations to cluster nodes 220-1 through 220-N to apply in memory distribution in FeedForwardNN forward and backward propagations, distribution in attention blocks which are inherently parallelizable across processing resources.

Thus, in embodiments, node 220-0 further includes CPU cluster manager 225. CPU cluster manager 225 intercepts or obtains the CPU and GPU based operations generated by GPU/CPU based ML training manager 222 and transforms those operations into CPU based operations for cluster processing. In some embodiments, CPU cluster manager 225 may be integrated into GPU/CPU based ML training manager 222, such as an additional software library. In the embodiments, CPU cluster manager 225 executes a distributed processing system that utilizes CPU based operations and in-memory processing. For example, CPU cluster manager 225 is configured to execute an Apache Spark framework for distributing and tracking the ML training operation in-memory and to the processing resources of the ML training CPU cluster nodes 220-1 thought 220-N. In embodiments, CPU cluster manager 225 therefore utilizes a Spark driver to distribute processing tasks to CPU cluster nodes 220-1 through 220-N that each execute Spark executors for processing their assigned tasks. For example, the tasks may be used to distribute, process and store x86 CPU based processing operations using Spark RDDs.

In embodiments, to benefit from the shared cluster memory and CPU resources of the cluster of CPU cluster nodes 220-1, CPU cluster manager 225 further performs operation orchestration. For example, CPU cluster manager 225 intercepts the GPU and CPU ML training operations, and transforms each operation to a corresponding x86 CPU operation, such as a Spark job. For example, if a GPU based matrix operation is received specifying input data and the operation to be performed, the matrix operation is transformed into one or more corresponding x86 CPU based operations/jobs (e.g., obtain the same result using the same input data). Once transformed, the x86 CPU operations/jobs are scheduled for execution on the cluster nodes 220-1 through 220-N using the Spark distribution framework. Furthermore, the orchestration can include controlling the ML training flow, such as causing execution of each neuron of a ML model layer so that each layer's neuron results are generated before moving to a next layer of the ML model.

Results are then reported back to CPU cluster manager 225, which transforms the results into a form understood by GPU/CPU based ML training manager 222, and a next set of GPU/CPU training operations are generated until training concludes. It should be noted that GPU/CPU based ML training manager 222 generates both forward pass and back propagation operations, which are parallelized using the distribute x86 architecture as discussed herein.

For fully connected models, such as the model illustrated in FIG. 4A, the distribution and orchestration techniques performed by CPU cluster manager ensures that when processing layer N+1, all layer N neuron results are completed, and are available in the cluster's shared memory. This avoids any network based communication, delay in performing a layer's operations, etc., which effectively results in a much more processing, energy, and time efficient training of a ML model. For example, the overall training time of a large language model can be reduced by 10 or more times as a result of the efficiency gains enabled through the use of the x86 distribution, which can reduce overall training time from a year or more of required LLM training time to months of LLM training time.

Furthermore, ML training CPU cluster node 220-0 enables compute dense operations such as DL computational graphs to be performed exhaustively at the granularity of individual vectorized features based matrix operations.

Breaking down algorithms into coarse grain computations at any level to enable some level of distribution can accumulate loss at unexpected rates in neural network or large language model training. However, by ML training CPU cluster node 220-0 using the x86 distribution approach, all computations are performed exhaustively so that there is no loss. Furthermore, any coarse-grained distribution that requires the reconciliation of edge effects or loss to accumulate is a non-starter, thus the no loss approach of ML training CPU cluster node 220-0 ensures validity.

In embodiments, ML training CPU cluster node 220-0 further defines a process of advanced mathematical modeling to identify the optimal key/value pair representation, which maintains processing dependencies through the modeling of key/value pairs. In an embodiment, for example, every one of the encoder decoder stacks in transformer computations will be performed and for all epochs. In this embodiment, nothing will be combined across smaller subsets of data, or any other alteration of model architecture will be performed. Leveraging underlying DAG based execution of neural network computational graphs in memory without having to exchange any parameters between nodes will result in performance gains for ML training architecture 215 not realized in other distributed learning systems, such as systems that rely on GPU based distribution.

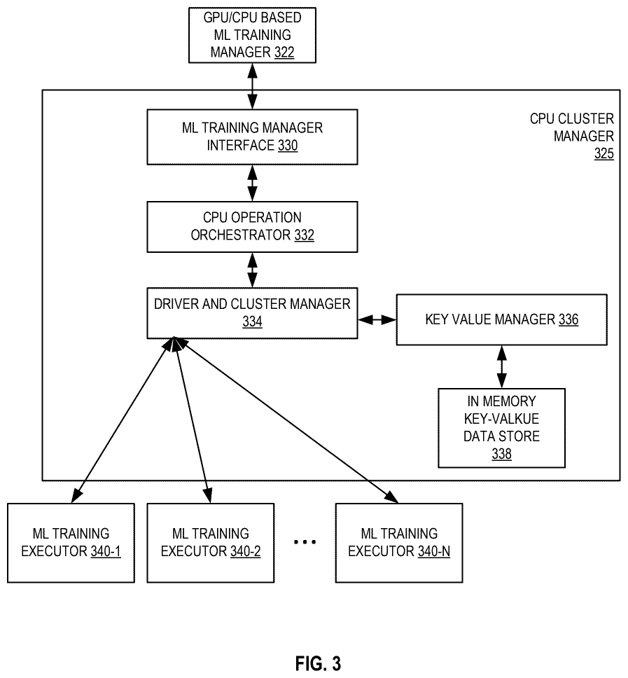

FIG. 3 is a block diagram of one embodiment of a CPU cluster manager 325 of a machine learning training computing cluster architecture (e.g., architecture 215). CPU cluster manager 325 provides additional detail for the CPU cluster manager 225 discussed above in FIG. 2.

CPU cluster manager 325 includes a ML training manager interface 330, CPU operation orchestrator 332, driver and cluster manager 334, and key value manager 336, each of which is a processing logic that may comprise hardware (circuitry, dedicated logic, etc.), software (such as is run on a general-purpose computer system or a dedicated machine), firmware, or a combination thereof.

ML training manager interface 330 is configured to receive GPU/CPU hardware training operations, such as those generated by the GPU/CPU based ML training manager 322. As discussed herein, GPU/CPU based ML training manager 322 executes a ML training framework, such as Pytorch, that manages and generates ML training operations including generating hardware based commands (e.g., matrix operations, memory commands, etc. during forward pass training operations, and weight adjustment computations during backward pass error propagation).

The operations can include, for example, the operation type, the operation data, Pytorch tracking identifiers, metadata, etc. ML training manager interface 330 therefore intercepts all the operations generated by the GPU/CPU based ML training manager 322, which are then passed to CPU operation orchestrator 332.

CPU operation orchestrator 332 is responsible for transforming each Pytorch operation to one or more Spark jobs. For example, matrix operations are transformed to corresponding matrix operations, identifiers are moved and/or transformed to appropriate data fields within the Spark job(s), metadata is transformed and/or written to the appropriate metadata fields within the Spark job(s), etc. Therefore, each Pytorch training operation is mapped and transformed to the corresponding Spark job for execution by a distribution of processing nodes. As an example, one command used in Pytorch is the Cross Entropy Loss calculation that can be invoked as torch.nn.CrossEntropyLoss. CPU operation orchestrator 332 transforms or maps the Pytorch function torch.nn.CrossEntropyLoss to one or more Spark processing job(s) so that each final layer nodes loss can be distributed to cluster computing nodes (e.g., nodes 220-1 through 220-N of FIG. 2) and computed in parallel in Spark. Other operations generated by Pytorch may similarly be mapped or converted into one or more corresponding Spark operations and orchestrated for parallel execution using x86 processing jobs, as discussed herein.

CPU operation orchestrator 332 further collects the Spark job(s) for the plurality of generated Pytorch operations, which is shared with driver and cluster manager 334. The orchestrator 332 and manager 334 collectively arrange and schedule the Spark jobs for execution by executors 340-1 through 340-N. As discussed herein, this can include generating a DAG that defines a sequence of operations to achieve a processing result by transforming Spark RDDs. In embodiments, the DAG is configured to cause executors to execute each layer of a model being trained in parallel using the processing resources and shared cluster memory of the cluster nodes containing the executors 340-1 through 340-N. Thus, for fully connected or highly connected ML models, completion of each layer's neuron operations ensures operations performed for a next layer are not delayed (e.g., eliminating lag in the ML training), and also ensuring that each layer's neuron operations will have access to the in-memory results from all prior layers'operations results (e.g., providing extremely fast CPU access to needed data results). These features ensure that parallel computation of each layer's neurons occurs through the cluster manager 325 and executors 340-1 through 340-N to realize significant performance gains (e.g., magnitudes of gain) over existing ML training systems that experience memory and processing bottlenecks, incur lag due to required network based communications, serialize what should be parallel operations, etc.

Furthermore, the generated CPU (e.g., x86) operations mapped from the Pytorch operations, are further accessed by key value manager 336 which is responsible for generating a persistent record for a given operation's key (e.g., a unique identifier assigned to a CPU operation by Pytorch or by driver and cluster manager 334). Then, when executors 340-1 through 340-N complete their operations, the values generated by executors and stored in cluster memory, can be associated with the keys in the in memory key-value data store 338. Thus, lineage of operations, and values generated by those operations, the in-memory locations of the operation results, etc. is stored and accessible to driver and cluster manager 334. Thus, later ML layer operations or back propagation error processing can access any of the in-memory results from cluster RAM enabling fast access to the results without delay or communication lag experienced by other systems, minimizing power consumption of processing resources, and freeing processing resources to continue ML training sooner, than other ML training systems.

Additionally, in the event a processing node (e.g., one or nodes 320-1 through 320-N) responsible for executing one or more of executors 340 goes down or experiences another form of error, the operations that should have been executed can be recalled from the DAG, redistributed to executors 340-1 through 340-N by driver and cluster manager 334, and results added to the in-memory storage and associated with their respective keys. Again, the use of, and access to, ensures that even in the event of a node failure, the delay in regenerating the data is minimal and orders of magnitude faster than other ML training system, which saves system power, frees processing resources sooner for continuing the training operations, and improves the power and computational efficiency of the ML training process.

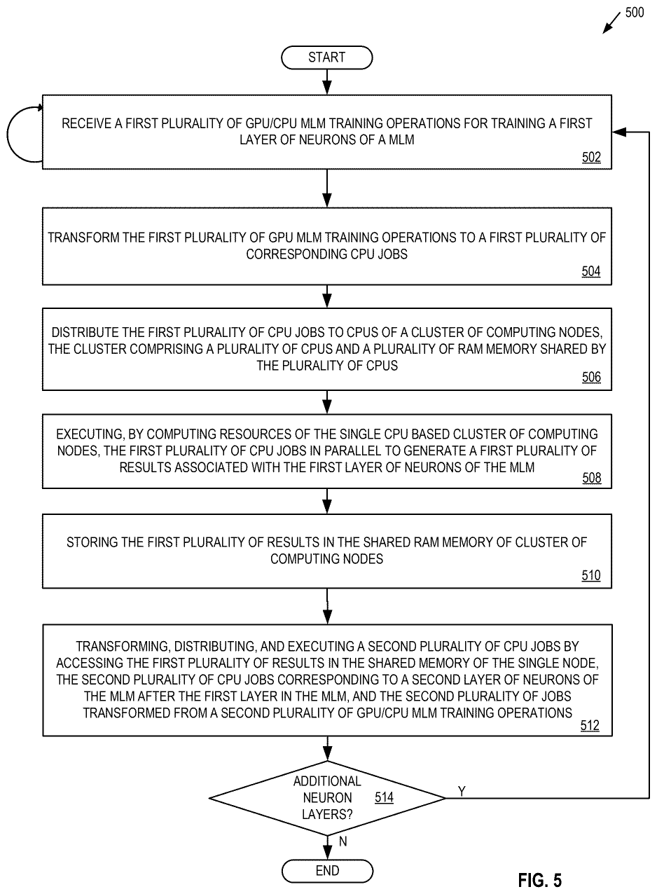

FIG. 5 is a block diagram of one embodiment of method 500 for orchestration CPU operations in a cluster of computing nodes for training a machine learning model. The method 500 is performed by processing logic that may comprise hardware (circuitry, dedicated logic, etc.), software (such as is run on a general-purpose computer system or a dedicated machine), firmware, or a combination thereof. In one embodiment, the method 500 is performed by an ML training system (e.g., ML training system 110 or 210).

Processing logic begins by receiving a first plurality of GPU/CPU MLM training operations for training a first layer of neurons of a MLM (processing block 502). As discussed herein, a first computing platform, such as the Pytorch framework enables a model to be defined (e.g., a neural network with a defined number of layers, connection between layers, neurons per layer, etc.). Modern large language models, which are defined in a framework such as Pytorch, can have hundreds of layer with thousands of neurons per layer, and each layer is fully connected to a next layer. Thus, modern LLMs are extremely large and complex, and frameworks like Pytorch are responsible for generating a plurality of tasks, distributed as hardware processing operations (e.g., GPU operations), to complete the tasks. For example, forward pass computation and prediction during training, as well as backward pass error propagation and neuron weight revision, are example of such tasks generated by Pytorch. Processing logic therefore receives a plurality of these tasks for a first layer of neurons of the machine learning model. The first layer may be the first, input layer of an MLM, an inner, hidden layer of the MLM, or a final, output layer of the MLM.

Processing logic transforms the first plurality of GPU MLM training operations to a first plurality of corresponding CPU jobs (processing block 504). As discussed herein, the training operations for the first layer can be transformed to CPU jobs, for example by mapping each GPU/CPU training operation to a corresponding CPU job that encodes one or more identifiers, data to be processed, etc. in a format of the CPU jobs. In some examples, the CPU jobs are transformed to, or mapped to, jobs of a second computing platform, such as Spark jobs in the form of RDDs (e.g., units of compute and memory) capable of being distributed to a cluster of CPUs as x86 processing jobs.

Processing logic distributes the first plurality of CPU jobs to CPUs of cluster of computing nodes, the cluster comprising a plurality of CPUs and a plurality of RAM memory shared by the plurality of CPUs (processing block 506). The distribution, in embodiments, is determined and then performed using a driver and cluster manager of the second computing platform, such as a Spark driver. Furthermore, the distribution is to the plurality of CPUs that have access to, and use, the plurality of shared RAM memory.

Processing logic executes, by the CPUs of the cluster of computing nodes, the first plurality of CPU jobs in parallel to generate a first plurality of results associated with the first layer of neurons of the MLM (processing block 508). In embodiments, the neurons of the first layer of the MLM are fully connected to other layers of the MLM, but not to the neurons of the existing layer. In embodiments, processing logic orchestrates the execution of each layer's and neurons training jobs for execution of the layer in parallel using the processing and memory resources of the cluster of computing systems. Processing logic then stores the first plurality of results in the shared RAM memory of the cluster of computing nodes (processing block 510). Thus, using the CPU resources of the cluster of computing nodes, training operations executed for all neurons of the first layer can be performed in parallel. Such parallel execution significantly speeds up the processing of each layer's training operations over existing techniques, where such existing techniques having limited processing and memory resources result to tensor distribution and effectively serialize the training process.

Processing logic transforms, distributes, and executes a second plurality of CPU jobs by accessing the first plurality of results in the shared RAM memory of the cluster of computing nodes, the second plurality of CPU jobs corresponding to a second layer of neurons of the MLM after the first layer in the MLM, and the second plurality of jobs transformed from a second plurality of GPU/CPU MLM training operations (processing block 512). Similar to the discussion above, the execution of the second layer's training jobs is orchestrated for execution in parallel. Thus, each subsequent layer is orchestrated by processing logic for parallel execution. The presently claimed technique utilizes the shared RAM memory of the cluster for processing each next layer of an MLM, where the RAM memory is high speed, direct-access memory. Thus, each subsequent layer of an MLM, which is orchestrated to execute its CPU training jobs in parallel, has direct and high-speed in-memory access to all inputs/results of a prior layer of CPU jobs, which are stored and persisted in the RAM of the cluster of computing nodes. Using the shared cluster RAM memory, which provides a large memory footprint on the magnitude of terabytes of more of available RAM, significantly speeds up each layer's training job execution by providing the processing jobs direct access to any and all needed data. This avoids storage lag and network based communications incurred by existing training techniques, which are slow and consume unnecessary resources during the model training process.

Processing logic then determines whether an additional layer of neurons exists in the ML model being trained (processing block 514). When there are one or more additional model layers to be processed, the process returns to processing block 502. When there are no more layers to be process, the process ends.

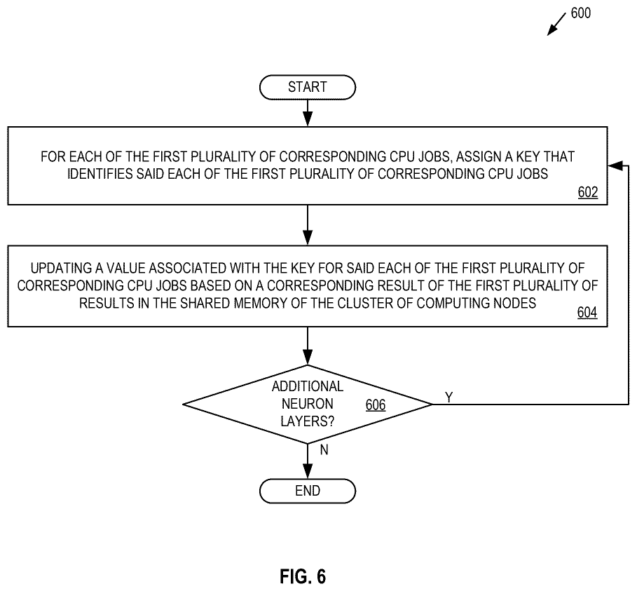

FIG. 6 illustrates one embodiment of a method for using keys and values when orchestrating CPU operations in a cluster of computing nodes. The method 600 is performed by processing logic that may comprise hardware (circuitry, dedicated logic, etc.), software (such as is run on a general-purpose computer system or a dedicated machine), firmware, or a combination thereof. In one embodiment, the method 600 is performed by an ML training system (e.g., ML training system 110 or 210).

Processing logic begins by, for each of the first plurality of corresponding CPU jobs, assign a key that identifies said each of the first plurality of corresponding CPU jobs (processing block 602). The first plurality of corresponding CPU jobs are those jobs generated and discussed above at processing block 504 of FIG. 5. Thus, each job, such as each Spark job to be executed as an x86 processing by a resource of the cluster of computer systems, is assigned a unique identifier in the form of the key.

Processing logic updates a value associated with the key for said each of the first plurality of corresponding CPU jobs based on a corresponding result of the first plurality of results in the shared memory of the cluster of computing nodes (processing block 604). By assigning a key to each job and its results, distribution can be tracked in an in-memory key-value data store (e.g., data store 338), which is maintained in the massive RAM memory footprint of the cluster of computing systems. Thus, a lineage can be formed to enable, for example, job execution confirmation, re-execution in the event of node failure, etc.

In embodiments, a key value manager (e.g., manger 336) interacts with a driver and cluster manager (e.g., manager 334) to assign keys, and update an in memory key-value data store as discussed herein.

Processing logic then determines whether an additional layer of neurons exists in the ML model being trained (processing block 606). When there are one or more additional model layers to be processed, the process returns to processing block 602 for assignment, tracking, and storage of keys and associated values computed from CPU jobs, as discussed above. However, when there are no more layers to be process, the process ends. Furthermore, as discussed herein, the key-value data store is persisted in the RAM of the cluster of computing systems, which is used during the processing performed above in FIG. 5 so that each layer of neuron training has direct key-value based access to all data of a prior layer.

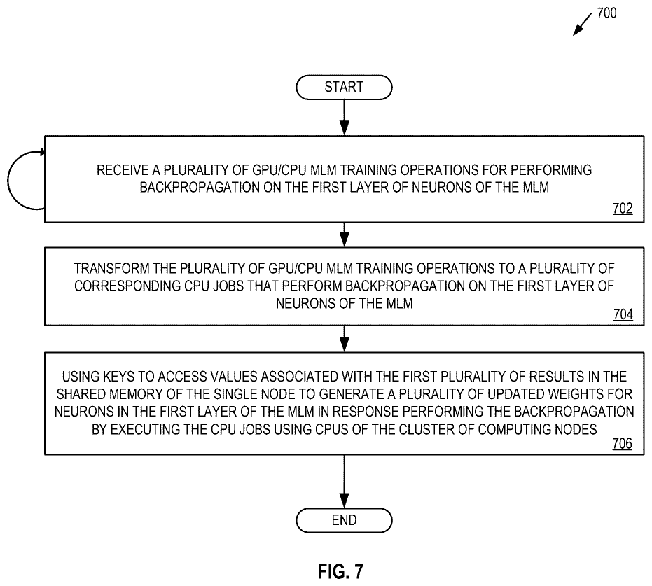

FIG. 7 illustrates one embodiment of a method for using in-memory data during orchestrated CPU backpropagation operations in a cluster of computing nodes. The method 700 is performed by processing logic that may comprise hardware (circuitry, dedicated logic, etc.), software (such as is run on a general-purpose computer system or a dedicated machine), firmware, or a combination thereof. In one embodiment, the method 700 is performed by an ML training system (e.g., ML training system 110 or 210).

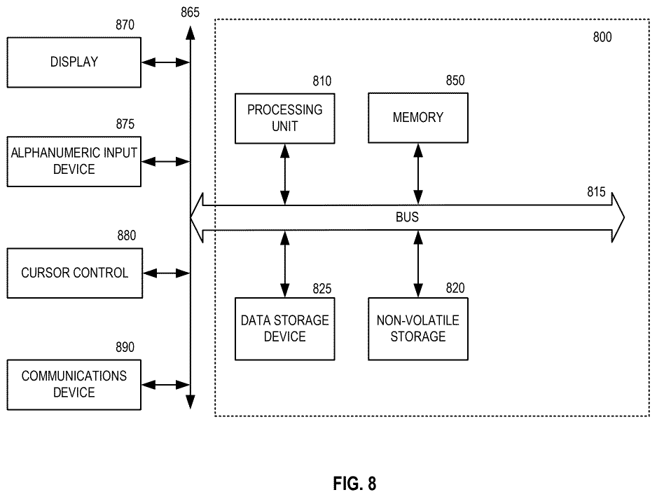

Processing logic begins by receiving a plurality of GPU/CPU MLM training operations for performing backpropagation on the first layer of neurons of the MLM (processing block 702). Similar to the discussion herein, the plurality of operations are backpropagation operations generated by a MLM training framework, such as Pytorch. Furthermore, the backpropagation operations are operations generated after each forward training pass of an MLM, and are used to update the MLM's parameters, as discussed herein
1. Processing logic transforms the plurality of GPU/CPU MLM training operations to a plurality of corresponding CPU jobs that perform backpropagation on the first layer of neurons of the MLM (processing block 704). Processing logic then uses keys to access values associated with the first plurality of results in the shared RAM memory of the cluster of computing nodes to generate a plurality of updated weights for neurons in the first layer of the MLM in response performing the backpropagation by executing the CPU jobs using CPUs of the cluster of computing nodes (processing block 706). Therefore, the backpropagation jobs executed by processing logic also use the shared memory and processing results persisted in the shared memory. By persisting the results of the forward pass training operations, processing logic can access the results using keys (e.g., that identify neuron operations) to access the associated values from an in memory data store, to avoid re-computation of these results during the error correction processes of MLM training. Thus, backpropagation efficiency and parallelization is also improved using the CPU based execution architecture and shared memory, as discussed herein.
2. FIG. 8 is one embodiment of a computer system that may be used to support the systems and operations discussed herein. It will be apparent to those of ordinary skill in the art, however that other alternative systems of various system architectures may also be used. In embodiments, the computer system may be used to implement ML training system 110, the CPU cluster manager 225, etc. as discussed herein. Furthermore, the computer system may be used to implement distributed nodes, such as the cluster node (e.g., nodes 220-0 through 220-N) of the training system 210, used to process RDDs as discussed herein.

The data processing system illustrated in FIG. 8 includes a bus or other internal communication means 815 for communicating information, and one or more processors (e.g., processor 810) coupled to the bus 815 for processing information. The system further comprises a random access memory (RAM) or other volatile storage device 850 (referred to as memory), coupled to bus 815 for storing information and instructions to be executed by processor 810. Main memory 850 also may be used for storing temporary variables or other intermediate information during execution of instructions by processor 810. The system also comprises a read only memory (ROM) and/or static storage device 820 coupled to bus 815 for storing static information and instructions for processor 810, and a data storage device 825 such as a magnetic, optical, solid storage, or other data storage device. Data storage device 825 is coupled to bus 815 for storing information and instructions.

The system may further be coupled to a display device 870, such as for example a light emitting diode (LED) display or a liquid crystal display (LCD) coupled to bus 815 through bus 865 for displaying information to a computer user. An alphanumeric input device 875, including alphanumeric and other keys, touch screens, etc., may also be coupled to bus 815 through bus 865 for communicating information and command selections to processor 810. An additional user input device is cursor control device 880, such as a touchpad, mouse, a trackball, stylus, or cursor direction keys coupled to bus 815 through bus 865 for communicating direction information and command selections to processor 810, and for controlling cursor movement on display device 870.

Another device, which may optionally be coupled to computer system 800, is a communication device 890 for accessing other nodes of a distributed system via a network. The communication device 890 may include any of a number of commercially available networking peripheral devices such as those used for coupling to an Ethernet, token ring, Internet, or wide area network. The communication device 890 may further be a null-modem connection, or any other mechanism that provides connectivity between the computer system 800 and the outside world. Note that any or all of the components of this system illustrated in FIG. 8 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 850, mass storage device 825, or other storage medium locally or remotely accessible to processor 810.

It will be apparent to those of ordinary skill in the art that the system, method, and process described herein can be implemented as software stored in main memory 850 or read only memory 820 and executed by processor 810. This control logic or software may also be resident on an article of manufacture comprising a computer readable medium having computer readable program code embodied therein and being readable by the mass storage device 825 and for causing the processor 810 to operate in accordance with the methods and teachings herein.

The embodiments discussed herein may also be embodied in a handheld or portable device containing a subset of the computer hardware components described above. For example, the handheld device may be configured to contain only the bus 815, the processor 810, and memory 850 and/or 825. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 810, a data storage device 825, a bus 815, and memory 850, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

We claim:

1. A method for distributing training of a machine learning model using hardware resources of a cluster of computing nodes, the method comprising:
receiving, by a first computing node of the cluster of computing nodes, a first plurality of graphics processing unit (GPU) machine learning model (MLM) training operations for training a first layer of neurons of a MLM;
transforming, by the first computing node of the cluster of computing nodes, the first plurality of GPU MLM training operations to a first plurality of corresponding central processing unit (CPU) jobs;
distributing, by the first computing node to a set of computing nodes of the cluster of computing nodes, the first plurality of CPU jobs, the first computing node and the set of computing nodes of the cluster of computing nodes comprising a plurality of CPUs and a plurality of RAM memory shared by the cluster of computing nodes;
executing, by CPUs of the set of computing nodes, the first plurality of CPU jobs in parallel to generate a first plurality of results associated with the first layer of neurons of the MLM; and
storing, by the CPUs of the set of computing nodes, the first plurality of results in the shared RAM memory of the cluster of computing nodes.

2. The method of claim 1, further comprising:
transforming a second plurality of GPU MLM training operations to a second plurality of corresponding CPU jobs
distributing the second plurality of corresponding CPU jobs to the set of computing nodes of the cluster of computing nodes; and
executing the second plurality of corresponding CPU jobs by accessing the first plurality of results in the shared RAM memory of the cluster of computing nodes, the second plurality of corresponding CPU jobs corresponding to a second layer of neurons of the MLM after the first layer in the MLM.

3. The method of claim 1, wherein executing the \first plurality of CPU jobs in parallel comprises:
orchestrating, by a driver executed by the first computing node, the execution of the first plurality of CPU jobs in parallel by distributing each of the first plurality of CPU jobs to different CPUs of the set of computing nodes of the cluster of computing nodes.

4. The method of claim 1, further comprising:
for each of the first plurality of CPU jobs, assigning a key that identifies said each of the first plurality of CPU jobs; and
updating a value associated with the key for said each of the first plurality of CPU jobs based on a corresponding result of the first plurality of results in the shared RAM memory of the cluster of computing nodes.

5. The method of claim 4, further comprising:
receiving a plurality of GPU MLM training operations for performing backpropagation on the first layer of neurons of the MLM;
transforming the plurality of GPU MLM training operations to a plurality of corresponding CPU jobs that perform backpropagation on the first layer of neurons of the MLM;
access values using keys associated with the first plurality of results in the shared RAM memory of the cluster of computing nodes; and
performing the backpropagation by executing the CPU jobs using CPUs of the set of computing nodes of the cluster of computing nodes to generate a plurality of updated weights for neurons in the first layer of the MLM.

6. The method of claim 1, wherein each of the first plurality of corresponding CPU jobs is an x86 processing job.

7. The method of claim 1, wherein the first plurality of GPU MLM training operations are Pytorch operations, and the first plurality of corresponding CPU jobs are Spark processing jobs.

8. The method of claim 1, wherein each of the first plurality of CPU jobs comprises a combination of a computational task and data for carrying out the computational task, wherein the distributed training operations are comprised in resilient distributed datasets (RDDs), and wherein two or more subsets of RDDs are distributed to two or more computing nodes of the set of computing nodes.

9. The method of claim 1, wherein the first layer is a first, input layer of the MLM, an inner, hidden layer of the MLM, or a final, output layer of the MLM.

10. The method of claim 1, wherein each neuron of the second layer is fully connected to the neurons of the first layer of the MLM.

11. The method of claim 1, wherein the MLM comprises a large language model.

12. The method of claim 1, wherein the MLM comprises a transformer model.

13. A non-transitory machine readable storage medium, having instructions stored thereon, which when executed by a computer processing system causes the computer processing system to perform operations for distributing training of a machine learning model using hardware resources of a cluster of computing nodes, the method comprising:
receiving, by a first computing node of the cluster of computing nodes, a first plurality of graphics processing unit (GPU) machine learning model (MLM) training operations for training a first layer of neurons of a MLM;
transforming, by the first computing node of the cluster of computing nodes, the first plurality of GPU MLM training operations to a first plurality of corresponding central processing unit (CPU) jobs;
distributing, by the first computing node to a set of computing nodes of the cluster of computing nodes, the first plurality of CPU jobs, the first computing node and the set of computing nodes of the cluster of computing nodes comprising a plurality of CPUs and a plurality of RAM memory shared by the cluster of computing nodes;
executing, by CPUs of the set of computing nodes, the first plurality of CPU jobs in parallel to generate a first plurality of results associated with the first layer of neurons of the MLM; and
storing, by the CPUs of the set of computing nodes, the first plurality of results in the shared RAM memory of the cluster of computing nodes.

14. The non-transitory machine readable storage medium of claim 13, the operations further comprising:
transforming a second plurality of GPU MLM training operations to a second plurality of corresponding CPU jobs
distributing the second plurality of corresponding CPU jobs to the set of computing nodes of the cluster of computing nodes; and
executing the second plurality of corresponding CPU jobs by accessing the first plurality of results in the shared RAM memory of the cluster of computing nodes, the second plurality of corresponding CPU jobs corresponding to a second layer of neurons of the MLM after the first layer in the MLM.

15. The non-transitory machine readable storage medium of claim 13, wherein the operations for executing the first plurality of CPU jobs in parallel comprises:
orchestrating, by a driver executed by the first computing node, the execution of the first plurality of CPU jobs in parallel by distributing each of the first plurality of CPU jobs to different CPUs of the set of computing nodes of the cluster of computing nodes.

16. The non-transitory machine readable storage medium of claim 13, the operations further comprising:
for each of the first plurality of CPU jobs, assigning a key that identifies said each of the first plurality of CPU jobs; and
updating a value associated with the key for said each of the first plurality of CPU jobs based on a corresponding result of the first plurality of results in the shared RAM memory of the cluster of computing nodes.

17. The non-transitory machine readable storage medium of claim 16, the operations further comprising:
receiving a plurality of GPU MLM training operations for performing backpropagation on the first layer of neurons of the MLM;
transforming the plurality of GPU MLM training operations to a plurality of corresponding CPU jobs that perform backpropagation on the first layer of neurons of the MLM;
access values using keys associated with the first plurality of results in the shared RAM memory of the cluster of computing nodes; and
performing the backpropagation by executing the CPU jobs using CPUs of the set of computing nodes of the cluster of computing nodes to generate a plurality of updated weights for neurons in the first layer of the MLM.

18. The non-transitory machine readable storage medium of claim 13, wherein each of the first plurality of CPU jobs comprises a combination of a computational task and data for carrying out the computational task, wherein the distributed training operations are comprised in resilient distributed datasets (RDDs), and wherein two or more subsets of RDDs are distributed to two or more computing nodes of the set of computing nodes.

19. The non-transitory machine readable storage medium of claim 13, wherein the MLM comprises a large language model or a transformer model.

20. A system for distributing training of a machine learning model using hardware resources of a cluster of computing nodes, system comprising:
a memory; and
a processor, coupled with the memory, the processor configured to perform operations, comprising:
receiving, by a first computing node of the cluster of computing nodes, a first plurality of graphics processing unit (GPU) machine learning model (MLM) training operations for training a first layer of neurons of a MLM;
transforming, by the first computing node of the cluster of computing nodes, the first plurality of GPU MLM training operations to a first plurality of corresponding central processing unit (CPU) jobs;
distributing, by the first computing node to a set of computing nodes of the cluster of computing nodes, the first plurality of CPU jobs, the first computing node and the set of computing nodes of the cluster of computing nodes comprising a plurality of CPUs and a plurality of RAM memory shared by the cluster of computing nodes;
executing, by CPUs of the set of computing nodes, the first plurality of CPU jobs in parallel to generate a first plurality of results associated with the first layer of neurons of the MLM; and
storing, by the CPUs of the set of computing nodes, the first plurality of results in the shared RAM memory of the cluster of computing nodes.
